(19) United States
(12) Patent Application Publication
(10) Pub. No.: US 2012/0124821 A1
(43) Pub. Date: May 24, 2012

(54) METHOD FOR PRODUCING GROUP OF ELECTRICAL COILS

(75) Inventor: Cornelius Lungu, Buehlertal (DE)

(73) Assignee: ELECTRIC DRIVE TECHNOLOGY, Steinhausen (CH)

(21) Appl. No.: 13/296,880

(22) Filed: Nov. 15, 2011

Related U.S. Application Data
(63) Continuation of application No. PCT/EP2010/001869, filed on Mar. 25, 2010.

(30) Foreign Application Priority Data
May 15, 2009 (EP) EP09006561.6

(51) Int. Cl. H02K 15/00

(52) U.S. Cl. 29/596

(57) ABSTRACT

A method for producing a group of electrical coils for electromagnetic applications includes providing at least one piece of a continuous ribbon conductor or a ribbon conductor stack of a predefined single length. The ribbon conductor is parted in a number n of linear conductor portions. The conductor portions are place in parallel to each other prior to winding. Thereafter the conductor portions are wound in order to create a group of coils composed of a corresponding number n of coils whereby the coils are connected with each other and are made of the same piece of continuous ribbon conductor or ribbon conductor stack.

### CROSS-REFERENCE TO RELATED APPLICATIONS

This application is a continuation of International Application No. PCT/EP2010/001869, filed Mar. 25, 2010, designating the United States and claiming priority to European Application No. EP 09006561.6 filed May 15, 2009.

### BACKGROUND OF THE INVENTION

This invention relates to groups of at least two electrical coils, such as those which are used in electrical motors, generators and electromagnets, made out of conductors which are not round wires. The coils according to this invention are realised with conductors of rectangular cross-section in order to achieve superior fill factors. Such groups of coils or windings are well known from the state of the art and are most often realised with rectangular cross-section conductors. These are in most cases made out of copper and typically insulated with materials such as wire enamel.

A major problem with such coils manufactured according to the state of the art is that they can only be satisfactorily realised with thicker conductors, making them more suitable for bigger machines. One of the biggest problems of manufacturing motors or generators with such rectangular section conductors is the special winding technique required, because the rectangular cross-section conductors have preferential bending directions and can only be processed on special machines.

Another problem of such groups of coils with non-round conductors when manufactured according to the state of the art is that several individual coils have to be connected together to realise the complex windings (e.g. phase windings) of an electrical machine. The interconnections (crossovers) between the single coils are often difficult to realise and these can reduce the reliability, performance and cost-effectiveness of the electrical machine.

### SUMMARY

This invention describes windings, especially motor windings, which are made out of groups of coils wound with rectangular cross-section conductors, all of these coils having been made out of a suitably plied single continuous predefined length AZ (FIG. 3) of a rectangular cross-section ribbon conductor (1) or several ribbon conductors piled together in a stack (3), s. also FIG. 1. This invention shows how a stack (3) made out of a plurality of thin ribbons (1) must be folded and handled in order to benefit from the fact that a plurality of thin conductors can be much more easily bent round sharp corners than a thick conductor having the same cross section. This is a major advantage of the groups of coils as described in this invention.

Piled conductors may be also favourable at higher frequencies because of the skin effect, which is reduced even if the piled conductors are only slightly insulated by thin oxide layers, (“litz-wire”-effect).

According to FIG. 3 the conductor predefined length AZ is parted in “n” (n=6 in FIG. 3) portions, which when wound in create a plurality (n) of coils.

The ribbon conductors (1) are placed parallel to each other prior to the winding process and wound together resulting in a group of coils which is composed of a plurality (n) but at least two coils which are perfectly connected with each other.

The perfect connection arises because all of the coils have been manufactured from the same continuous ribbon conductor(s) avoiding the need for crossovers which must be separately connected (e.g welded) to create the group of coils. The rectangular cross-section ribbon conductors are preferably made from copper or aluminium.

It is also an object of this invention to specify how the ribbon conductors 1 which are to be coiled, which are preferably cut from thin metal sheet, may be conveniently stacked in order to achieve the desired cross section of a conductor ribbon stack 3 using only a few shapes of single conductor ribbons 1.

It is also an object of this invention to show how the portions of conductor ribbon 1 or conductor ribbon stacks 3, which interconnect single coils SC or twin coils TC (crossovers), and the beginnings and the ends of these coil groups (connecting leads CL) have to be bent and folded in order to realise crossovers without supplementary joints.

These crossovers, being specially folded as per this invention, permit the spatial, three dimensional placement of single coils SC or twin coils TC which can be inserted onto magnetic yokes MY, so that a desired polarity will result at the pole pieces PP of said magnetic yokes.

It is not a specific matter of the invention how these conductors are insulated from each other. For the sake of clarity we will mention in this invention that the preferred insulation is comprised of insulating tapes 2, interleaved with the conductor ribbons, and the way in which this insulating tape is placed with respect to the conductor ribbons 1.

### DESCRIPTION OF THE DRAWINGS

FIG. 1a is a perspective view of a single, non-insulated rectangular conductor ribbon that may be used to implement the invention.

FIGS. 1b and 1b′ are perspective views of respectively a coated and uncoated conductor ribbon that may be used to implement the invention.

FIG. 1c is a perspective view of a conductor ribbon stack that may be used for implementing the invention.

FIG. 1d is a perspective view of a conductor ribbon stack additionally wrapped or coated with a second insulating tape for implementing the invention.

FIG. 2 illustrates a bent or folded conductor ribbon useful in explaining the invention.

FIG. 3 is a top view a planar layout of an unwound single continuous length of a conductor ribbon that is multiply bent and folded that may be used to form a group of coils according to the invention.

FIG. 4a shows a perspective view of single coil made from conductor ribbon and FIGS. 4b, 4c, 4d and 4d′ show perspective views of different embodiments of twin coils made from conductor ribbon according to the invention.

FIG. 5 is a perspective view of a group of two twin coils with two parallel winding shafts according to an embodiment of the invention made in accordance with the principles of the invention.

FIG. 6 is shows a perspective view of a group of coils including two twin coils slid onto two U-shaped magnetic yokes according in accordance with the principles of the invention.

FIG. 7 illustrates a three dimensional layout for making a group of coils show in FIG. 8.

FIG. 8 shows a perspective view of another embodiment of a group of twin coils made from the special layout of FIG. 7 according to the principles of the invention.

### DETAILED DESCRIPTION

In order to better understand the invention we will begin with the conductor ribbon 1 and the conductor ribbon stacks 3 which are preferably used when implementing this invention.

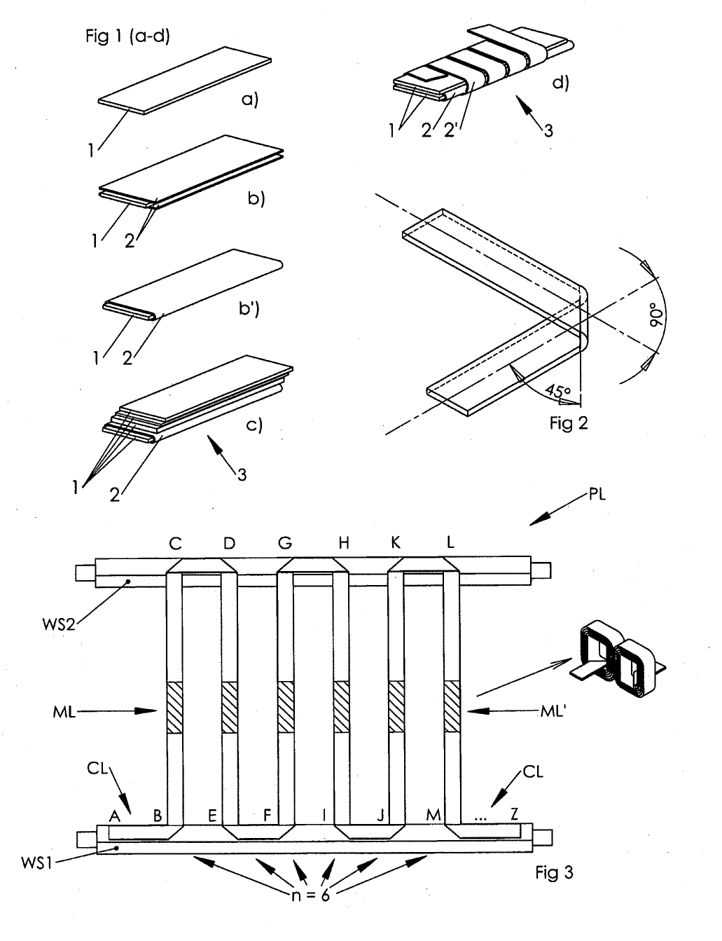

All of the groups of coils described in this invention can be made with a single or multiple current paths. This means that by winding a conductor ribbon stack 3 (such as that shown in FIG. 1c) it is possible to have a coil or group of coils with one or more internal current paths, which result from the galvanic separation of the single conductor ribbons 1 or of groups of several conductor ribbons 1 by means of an insulating tape 2, for example. A preferred winding with two current paths according to the invention is designated a bifilar winding.

FIG. 1a represents a single, non-insulated rectangular cross-section conductor ribbon 1 of undefined length which is, for example, cut out of a thin metal sheet and which can have, for example, a thickness h of down to 0.02 mm and a suitable width w which can vary from tenths of millimetres up to decimetres.

FIG. 1b, b′ represent a similar conductor ribbon 1 which is coated 1B or wrapped 1b′ with an insulating tape 2. Stacking together several conductor ribbons 1 as represented in the FIGS. 1a and 1b results in a conductor ribbon stack 3 as shown in FIG. 1c, this being an example of conductor ribbon stack 3 suitable for a bifilar winding. Here, the first current path is composed of the three upper conductor ribbons 1, while the second current path is the bottom insulated conductor ribbons 1.

The conductor ribbons 1 of the conductor ribbon stack 3 can have different thicknesses, so that a suitable cross-section for each separate current path can be realised. The resulting turns after the coiling process are insulated from each other by the insulating tape 2 and thus they can be connected separately as two galvanically insulated (bifilar) interleaved coils, i.e. two independent current paths are present.

In this case, the insulated conductors 1, (i.e. an insulated current path) act as a turn insulation also for the other not insulated conductors 1, (i.e. another current path).

FIG. 1d represents a conductor ribbon stack 3 comprising of one or more conductor ribbons 1, with or without insulating tapes 2. The ribbon stack 3 is additionally wrapped or coated with a second insulating tape 2′ in order to provide a supplementary insulation, which may be necessary in particular at the beginning or the end of a coil. Here the material stress is larger due to the sharp bending which results from the necessity of leading the conductor ribbons 1 tightly around a typically sharp-edged magnetic yoke.

In order to realise single coils and groups of coils (complete windings) it is necessary to bend and fold the conductor ribbons in a manner which is suitable for automatic manufacturing, and this way realize terminals or crossovers. This is possible by using typical bend and folding arrangements of ribbon conductor 1 or of ribbon conductor stacks 3, as shown in its most basic form in FIG. 2. This comprises a bend of usually 45° with respect to the lengthwise axis of the conductor ribbon 1, followed by a firm flat fold (the upside comes down) which renders an usually 90° direction change of the conductor ribbons 1 along their axes, the overlapped portion having about twofold the thickness of the conductor ribbon 1 or of the conductor ribbon stacks 3.

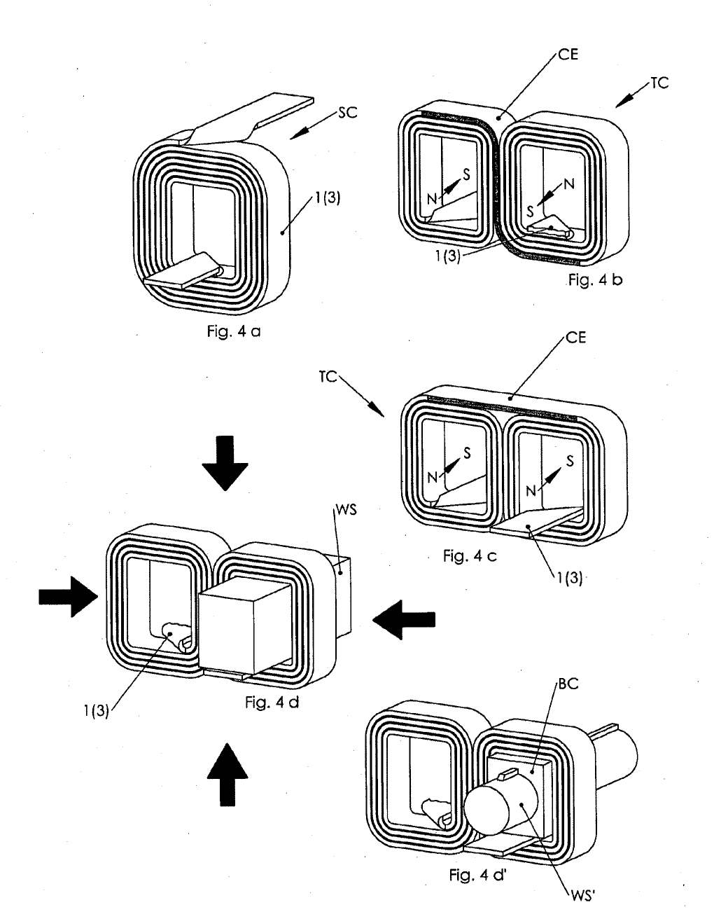

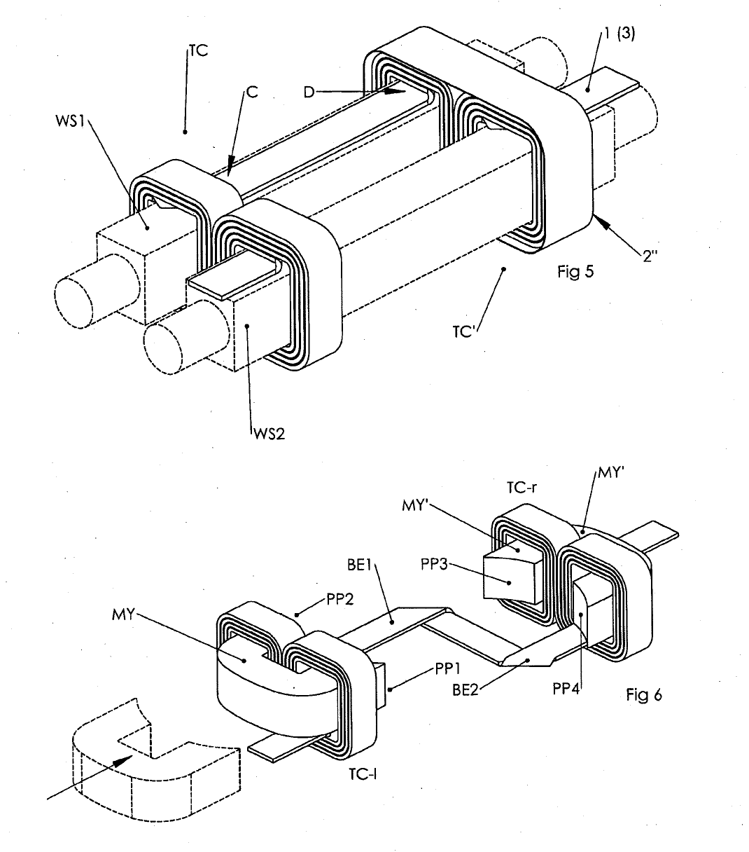

In order to realise a group of n coils (FIG. 3 shows n=6) out of a single continuous length of a conductor ribbon 1 or conductor ribbon stack 3, a predefined length A-Z of such conductor ribbon 1 or conductor ribbon stacks 3 will be multiply bent and folded as shown in FIG. 2 so that a planar layout PL arises as shown in FIG. 3, which represents the unwound form of the future group of coils. This planar layout PL has lower horizontal portions which will serve as terminals A-B, M- . . . Z of the first and the last (in this example the sixth) coils in the group. The upper crossovers in the finished group of coils will be formed by portions (C-D, G-H, K-L) and the lower crossovers will be formed by portions E-F, I-J. The six vertical portions B-C, D-E, F-G, H-I, J-K, L-M of the conductor ribbon 1 or of conductor ribbon stacks 3 will be wound as a spiral and form, in this example, six single coils SC or six twin coils TC, as described in FIG. 4. The terminals A and Z (FIG. 3) serve as connecting leads CL of the group of coils.

To simultaneously wind single coils SC, (FIG. 4a) only a lower winding shaft WS1 (FIG. 3) of convenient shape must exist and be driven. To produce twin coils TC (FIG. 4b, 4c) a second upper winding shaft WS2 is driven together with the lower winding shaft WS1. In this way a plurality n of (in this example n=6) single coils SC or twin coils TC can be produced simultaneously. The preferred shape for the lower and upper winding shafts WS1, WS2 will be chosen to match the desired shape and dimensions of the coil internal bores. For example for square-section coil bores the upper winding shaft WS1 and lower winding shaft WS2 will both have rectangular cross-section.

It is also possible to use separate, appropriately designed bobbin cores BC of a desired (e.g. square) cross-section, which can be mounted on and driven by winding shafts WS′.

FIGS. 4d and 4d′ show these two variants. In the latter case a bobbin core BC is mounted on the winding shaft WS′. After pulling the winding shaft WS′ out of the bobbin cores BC, these cores will stay inside the coils for the next manufacturing step or to be used as insulating bobbin carriers for the ready-mounted windings.

The terminals A-B, M- . . . Z and the crossovers C-D, E-F, G-H, I-J, K-L must be fixed by appropriate means (e.g. clamps, not shown) along one side of the winding shafts WS1, WS2, for the coiling process.

As the single coils SC or twin coils TC which are being realised by simultaneously winding of portions of the same ribbon conductor 1 or conductor ribbon stacks 3 are connected in series, care must be taken that the magnetic polarities of the resulting coils, when energized, correspond to the requirements of the machine or apparatus in which they are to be used.

If the winding process occurs at the lower side of the planar layout PL (FIG. 3) by driving only the lower winding shaft WS1, the single coils SC which result from the winding process will have their start at the side of the lower winding shaft WS1 and the ends of the coils will correspond to the upper crossovers C-D, G-H, K-L. If both the lower and upper sides of the planar layout PL are coiled by driving both the lower and upper winding shafts WS1, WS2, twin coils TC will result. Each resulting coil pair will end with a common portion (outer ends) joining the two halves of the twin coil TC. The common ends CE (see FIG. 4b, 4c, represented more clearly with a bold line correspond to the middle portions ML of the length of the vertical portions B-C, D-E, F-G, H-I, J-K, L-M, of the conductor ribbon 1 or conductor ribbon stacks 3 to be coiled.

It is of course necessary that the lower and upper winding shafts WS1, WS2 can move towards each other while winding twin coils TC or single coils SC. FIG. 4a represents a single coil SC and two variants of the twin coil TC, FIGS. 4b, 4c. In the variant shown in FIG. 4b the winding shafts WS1, WS2 must be driven in the same direction (clockwise), and in the variant shown in FIG. 4c the winding shafts WS1,WS2 must be driven in opposite directions (clockwise and counter-clockwise respectively).

The twin coils TC (FIG. 4c) resulting from driving both winding shafts WS1, WS2 in opposite directions will have a common end (bold line) bordering the two coils so that a DC- current which flows through them will produce poles of the same polarity (e.g. South, S) at the same side (front) of the twin coils. This may not be suitable for some applications.

The twin coils TC (FIG. 4b) resulting from driving both winding shafts WS1, WS2 in the same direction will have a common end represented with a bold line between the two coils which is diagonal, or S-shaped. This means that the polarities of the magnetic fields resulting from the flow of DC current have convenient polarities; at the same lateral side (e.g. front side) of the coils TC one (half of the twin) coil TC will generate a North (N) magnetic pole and the other (half of the twin) coil TC will generate a South (S) pole. If a magnetic circuit is completed by insertion of a U-shaped yoke, this configuration is suitable for most electromagnetic applications.

The total number of turns in a twin coil TC will be greater than the number of turns for the single coil SC, if they are made from the same length of the ribbon conductor. This is because the mean length of a turn in twin coil TC is shorter (see FIG. 4b, 4c) compared with the mean length of a turn in a single coil (SC), (FIG. 4a), where the outer turns are evidently longer. But the twin coils TC will have the same electrical resistance as the single coil SC, as the overall length of ribbon conductor is the same in both cases.

With the same current flow, the twin coils TC will therefore produce more Ampere-turns, which in turn means a greater electromagnetic effect than the single coil SC.

This makes twin coil TC arrangements as the preferred embodiment of the invention.

FIG. 5 represents a group of two twin coils TC, TC′ as they will result from the winding of the portion A-F of a planar layout according to FIG. 3 on two parallel winding shafts WS1, WS2 with rectangular cross section.

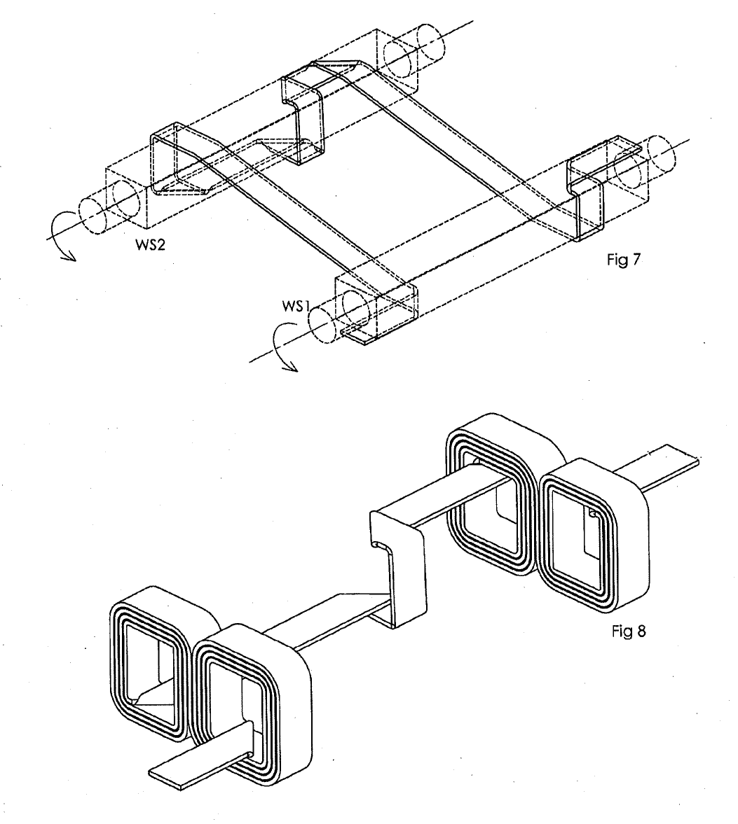

FIG. 6 represents a group of coils (a phase winding of a motor) which comprises two twin coils TC-I, TC-r slid onto two U-shaped magnetic yokes MY, MY′ (the arrow shows how the yokes are inserted).

The coil terminals and crossovers are bent and folded as shown in this figure prior to the completion of the winding process. Folded and bent in this way, the result is a magnetic circuit having four pole pieces PP1 . . . PP4, (for example as used in electric motors), whereby the pole pieces are the end faces of the U-shaped magnetic yokes MY, MY′.

The pole piece areas are a part of the internal circumference of the stator which surrounds the rotor of the electrical machine.

An arrangement such as in FIG. 6 is especially appropriate for motors and generators, because a rotor rotating between the pole pieces PP1 . . . PP4 (i.e. between the U-shaped magnetic yokes) will pass the pole pieces in the appropriate magnetic sequence (N-S, N-S).

Examples of motors and generators where groups of coils (motor phase windings) as described in this invention can be implemented are described in the international patent application WO 96/09683.

In order to get the configuration according to

FIG. 6, a direct crossover CD like that of FIGS. 3 and 5 must be folded twice (i.e. at the bends BE1, BE2 as show in FIG. 6) so that magnetic poles of different (North and South) polarity will face each other.

In order to practically realize a group of coils (a phase winding) according to FIG. 6, it is necessary to begin with a three dimensional layout which is more complicated than shown in FIG. 3. The required spatial layout SL is represented in FIG. 7.

The group of coils (phase winding) corresponding to FIG. 8 is produced by coiling the spatial layout SL represented in FIG. 7, which will be wound around the winding shafts WS1, WS2 (dotted line). The winding shafts WS1, 10 WS2 are removed after winding.

To create the desired configuration as shown in FIG. 6 from that shown in FIG. 8, it is necessary to twist, for example, the right-hand twin coils TC-r one half turn clockwise with respect to the left-hand ones (TC-I). This makes the portion between the bends BE1, BE2 straight and moves the terminals and crossovers to the correct position for suitable connection of the motor windings and the required magnetic polarisation of the pole pieces.

The mass production of the groups of coils (motor phase windings) as according to this invention also has other requirements regarding the shape and the stiffness of coils. Usually conductors, including ribbon conductors 1, have the tendency to spring back after releasing the strain put on them during the winding process.

In order to counteract this tendency, two solutions have proven to be practical: The first solution is to stick the single turns of the winding together. This can be achieved using usual measures, such as impregnating the coils with resin.

Continuous sticking of the turns produced while winding has proven to be practical. This is realized with a dispenser which applies a small quantity of liquid resin to the ribbon conductors 1 or inside the conductor ribbon stacks 3 during the winding process.

It is also possible to coat the conductor ribbons 1 in advance with an activator, 5 so that the resin which is applied during the winding process cures very quickly.

After the winding process is finished, it is possible to press the resulting single coils SC or twin coils TC with an adequate device, consisting mainly of pressing shoes. These press the above mentioned coils simultaneously from four directions, so that the resulting coil will come closer to a square shape (axial view) and cannot spring back.

The four bold arrows from FIG. 4d show the direction from which four flat pressing shoes (not represented) press on the four lateral faces of the twin coils TC.

The second way to keep the coils in shape is to secure them with an outer belt, (see FIG. 5,) which can also be realised using a supplementary insulating tape 2 (FIG. 1b).

The embodiments described in this application are simply examples of how to handle and use this novel kind of windings and do not define any restrictions on the applicability of the invention. The invention can be used in any suitable application to eliminate supplementary connections between single coils, improve manufacturing and reliability of electric machines and to reach superior fill factors.

1. A method for producing a group of electrical coils for electromagnetic applications, comprising:
providing at least one piece of a continuous ribbon conductor or a ribbon conductor stack of a predefined single length;
parting the ribbon conductor in a number n of linear conductor portions;
placing the conductor portions parallel to each other prior to a winding; and
winding the conductor portions in order to create a group of coils composed of a corresponding number n of coils whereby the coils are connected with each other and are made of the same piece of continuous ribbon conductor or ribbon conductor stack.

2. The method according to claim 1, wherein the winding includes winding the number n of linear conductor portions simultaneously beginning from both ends of the linear portion to produce multiple coils made of one piece and connected together through a median portion of the initial length of the ribbon conductor.
